(19) United States
(12) Patent Application Publication
(10) Pub. No.: US 2014/0254083 A1
(43) Pub. Date: Sep. 11, 2014

(54) Protection and Data Transmission Device Suitable for Use on a Portable Electronic Device

(71) Applicant: Hsin-Fu WANG, Chiayi City (TW)

(72) Inventor: Hsin-Fu WANG, Chiayi City (TW)

(21) Appl. No.: 13/791,993

(22) Filed: Mar. 9, 2013

(51) Int. Cl. G06F 1/16

(52) U.S. Cl. CPC G06F 1/16
USPC 361/679.31

(57) ABSTRACT

A protection and data transmission device suitable for use on a portable electronic device includes an inner cover, a transmission member, an outer cover assembly and a plurality of bolts. The transmission member is directly formed in the inner cover and have a USB connector and an electronic-device connector formed at two ends thereof, the user can insert the electronic device in the receiving chamber of the inner cover and connect the electronic-device connector to the connection port of the electronic device, which not only provides protection for the electronic device, preventing the electronic device from collision, but also prevents the connection port from being exposed to air and consequently preventing oxidization. Further, the electronic device can still perform data transmission and charging, without extra data transmission cable.

### BACKGROUND OF THE INVENTION

1. Field of the Invention

The present invention relates to a peripheral product for an electronic device, and more particularly to a protection and data transmission device suitable for use on a portable electronic device.

2. Description of the Prior Art

With the rapid development of science and technology, various portable devices have become very popular. It is well known that the electronic device will probably be damaged in case of fierce collision or when the internal parts are soaked in water. Therefore, most of the consumers would like to buy protection covers to cover the electronic devices. However, the protection covers only has the protection function, the user has to use a data cable as charging and signal transmission medium, and the charging and signal transmission can be performed only after the protection cover is removed, which brings much inconvenience to the user. On top of that, the data cable should be put away when it is not being used, and it is always difficult to find where it was put.

Therefore, a product as shown in FIG. 1 was made to solve the above problem, which is a flexible strip data cable 1 with a USB connector 12, at two ends of the strip data cable 1 are provided a first magnetic member 111 and a second magnetic member 112 which can be engaged with each other. When the data cable 1 is not being used, it can be formed into a ring shape by putting the first and second magnetic members 111, 112 together, and can be worn on the wrist or fastened to the straps of the bag carried by the user.

The present invention has arisen to mitigate and/or obviate the afore-described disadvantages.

### SUMMARY OF THE INVENTION

The conventional data cable for an electronic device can be worn on the wrist or fastened to the straps of the bag carried by the user. However, the data cable and the electronic device have to be carried by the user separately. Further, the connection port of the electronic device is always exposed to air and therefore vulnerable to oxidation when not connected to the data cable, and the data transmission capability will adversely affected.

The primary objective of the present invention is to overcome the abovementioned shortcomings.

To achieve the above objective, a protection and data transmission device suitable for use on a portable electronic device is provided by the present invention, the electronic device is provided with a connection port for connection of a power or signal cable, and the protection and data transmission device comprises an inner cover, a transmission member, an outer cover assembly and a plurality of bolts. The inner cover made of flexible material includes a receiving chamber for holding the electronic device. An upper opening and a lower opening are formed in the receiving chamber and located at two end surfaces of the inner cover. The transmission member made of flexible material is formed at one end of the inner cover and includes a USB connector and an electronic-device connector at two ends thereof. The electronic-device connector is located in the receiving chamber and connected to the connection port. The outer cover assembly is provided with a top cover to the upper opening and a bottom cover to cover the lower opening, and the outer cover assembly is formed with a plurality of assembling holes. The plurality of bolts are screwed in the assembling holes to assemble the top and bottom covers together.

The present invention is characterized in that: the transmission member is directly formed in the inner cover and have a USB connector and an electronic-device connector formed at two ends thereof, the user can insert the electronic device in the receiving chamber of the inner cover and connect the electronic-device connector to the connection port of the electronic device, which not only provide protection for the electronic device, preventing the electronic device from collision, but also prevent the connection port from being exposed to air and consequently preventing oxidization. Further, the electronic device can still perform data transmission and charging, without extra data transmission cable.

### BRIEF DESCRIPTION OF THE DRAWINGS

FIG. 1 is a perspective view of a conventional data transmission cable;

FIG. 2 is a perspective view of a protection and data transmission device suitable for use on a portable electronic device in accordance with a first embodiment of the present invention;

FIG. 3 is an exploded view of a protection and data transmission device suitable for use on a portable electronic device in accordance with the present invention;

FIG. 4 is a cross sectional view of the protection and data transmission device suitable for use on a portable electronic device in accordance with the present invention;

FIG. 5 is another cross sectional view of the protection and data transmission device suitable for use on a portable electronic device in accordance with the present invention;

FIG. 6 is an assembly view of the protection and data transmission device suitable for use on a portable electronic device in accordance with the present invention; and

FIG. 7 is an illustrative view of the protection and data transmission device suitable for use on a portable electronic device in accordance with another embodiment of the present invention.

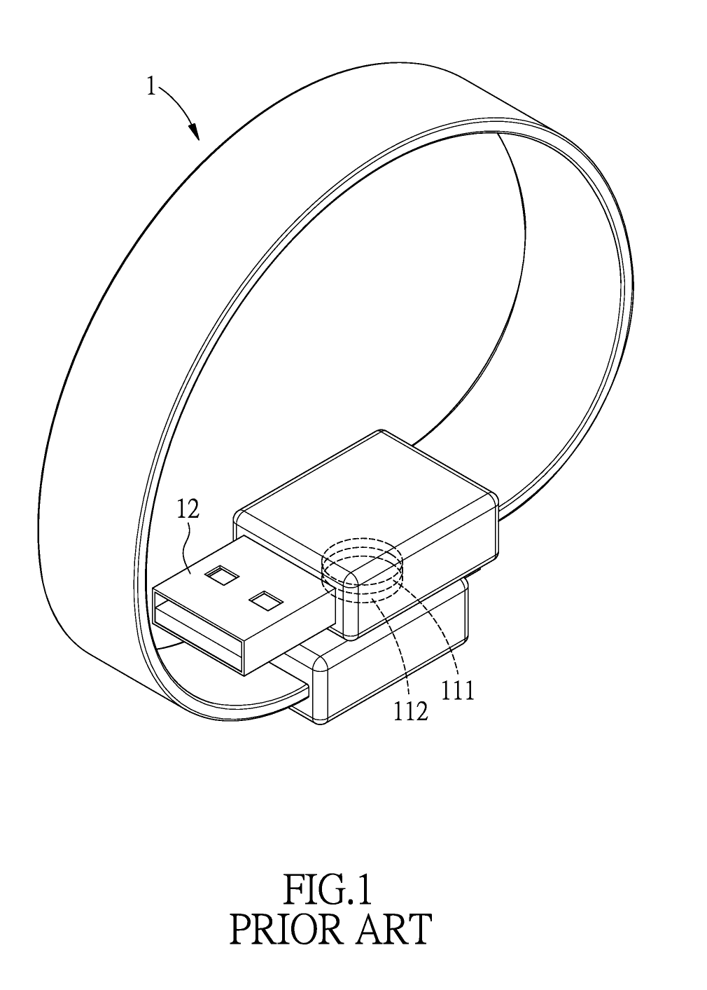

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

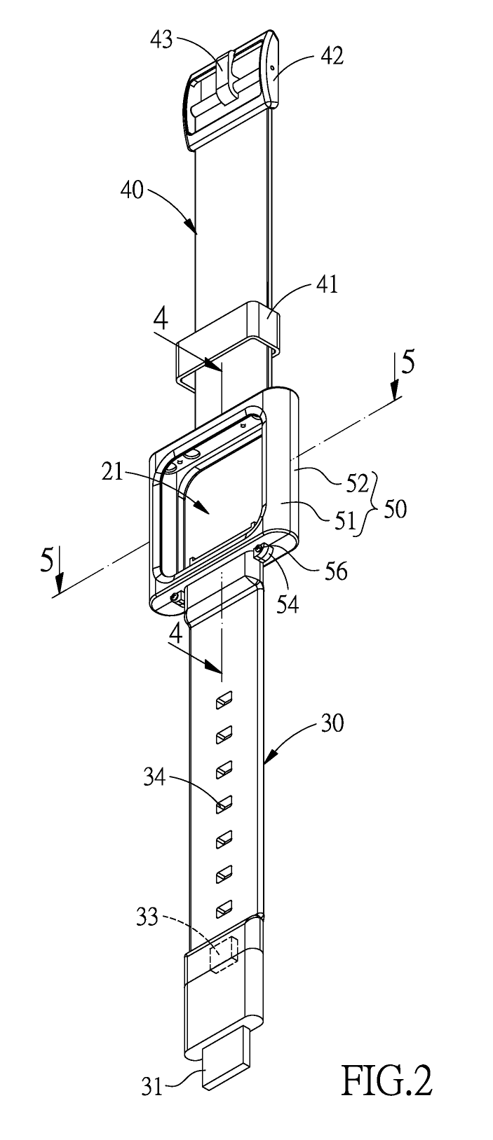

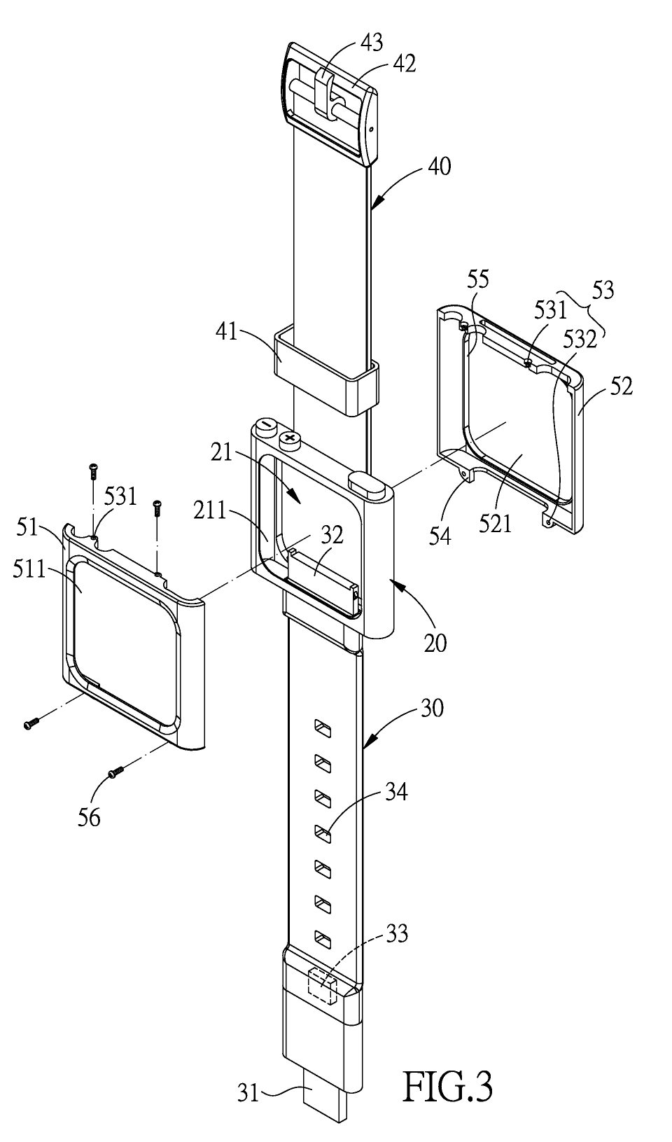

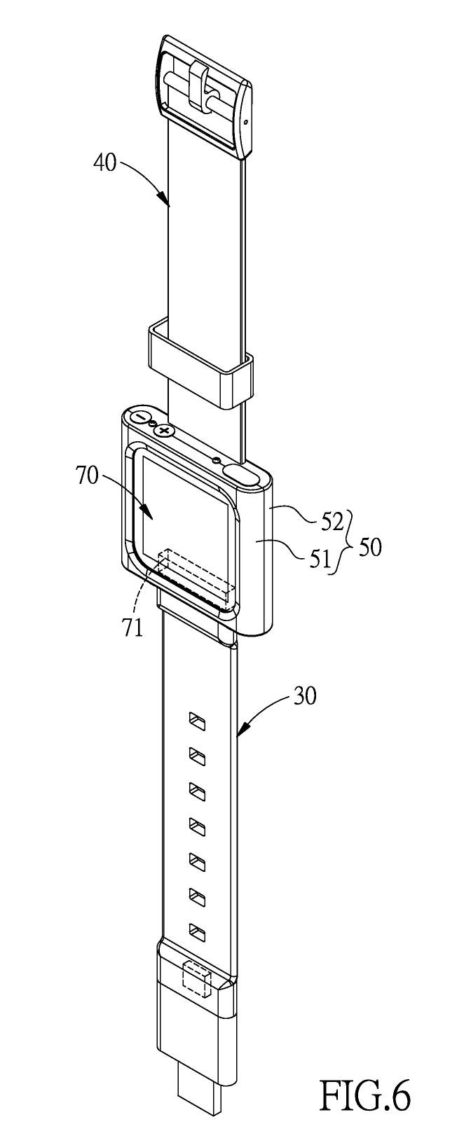

Referring to FIGS. 2-6, a protection and data transmission device suitable for use on a portable electronic device 70 in accordance with a first embodiment of the present invention comprises: an inner cover 20, a transmission member 30, an extension member 40, an outer cover assembly 50 and a plurality of bolts 56. The protection and data transmission device is in the shape of a watch. The electronic device 70 can be an iPod, iPhone, or a smart phone, and etc and is provided with a connection port 71 for connection of a power or signal cable.

The inner cover 20 is made of flexible material and in the shape of a watch case. The inner cover 20 includes a receiving chamber 21 for holding the electronic device 70. An upper opening 211 and a lower opening 212 are formed in the receiving chamber 21 and located at two end surfaces of the inner cover 20.

The transmission member 30 in the shape of a watch band is made of flexible material and formed at one end of the inner cover 20. The transmission member 30 has a USB connector 31 (Universal Serial Bus) and an electronic-device connector 32 at two ends thereof. The electronic-device connector 32 is located in the receiving chamber 21 and connected to the connection port 71. Signal transmission between the USB connector 31 and the electronic-device connector 32 is achieved by the transmission member 30. The electronic-device connector 32 can be a 30 pin connector, a USB connector or a mini USB connector adapted to the connection port 71 of different electronic devices 70. In the transmission member 30 is embedded a Bluetooth emitter 33, and the transmission member 30 is provided with a plurality of apertures 34.

The extension member 40 in the shape of a watch band is connected to another end of the inner cover 20 and made of flexible material. A locking member 41 is movably inserted on the extension member 40, and at the end of the extension member 40 are provided a locking frame 42 and a locking pin 43. The transmission member 30 is inserted in the locking frame 42 in such a manner that the locking pin 43 is inserted in one of the apertures 34, and the USB connector 31 of the transmission member 30 is inserted and restricted in the locking member 41.

The outer cover assembly 50 covers the inner cover 20 and includes a top cover 51 and a bottom cover 52. The top cover 51 covers the upper opening 211 and is formed with a top opening 511 aligned with the upper opening 211. The bottom cover 52 covers the lower opening 212 and is formed with a bottom opening 521 aligned with the lower opening 212. The outer cover assembly 50 is formed with a plurality of assembling holes 53, and each of the assembling holes 53 includes a longitudinal hole 531 and a transverse hole 532. The longitudinal holes 531 are formed in peripheral edges of the top and bottom covers 51, 52 and will be aligned in pairs when the outer cover assembly 50 covers the inner cover 20. The transverse holes 532 are formed on a plurality of ears 54 which are located on the top and bottom covers 51, 52, and the transverse holes 532 will be aligned in pairs when the outer cover assembly 50 covers the inner cover 20. The inner surface of the bottom cover 52 is formed an annular rib 55, and when the outer cover assembly 50 covers the inner cover 20, the annular rib 55 will be pushed against the outer surface of the inner cover 20.

The bolts 56 are screwed in the assembling holes 53 to assemble the top and bottom covers 51, 52.

When in use, as shown in FIGS. 2-6, the portable electronic device 70 is placed in the receiving chamber 21 of the inner cover 20 in such a manner that the electronic-device connector 32 is connected in the connection port 71 of the portable electronic device 70. Since the inner cover 20 is flexible, it can be deformed to hold the electronic device 70. The inner cover 20 covers the electronic device 70 to provide a protection and waterproof function. Then, the inner cover 20 is further sealed with the outer cover assembly 50, and the bolts 56 are fixed in the outer cover assembly 50 to prevent the electronic device 70 from falling off. Since the electronic device 70 is sealed with the inner cover 20, the connection port 71 can be prevented from oxidization. The present invention can be formed into a ring shape and worn on the wrist or fastened to the straps of the bag carried by the user.

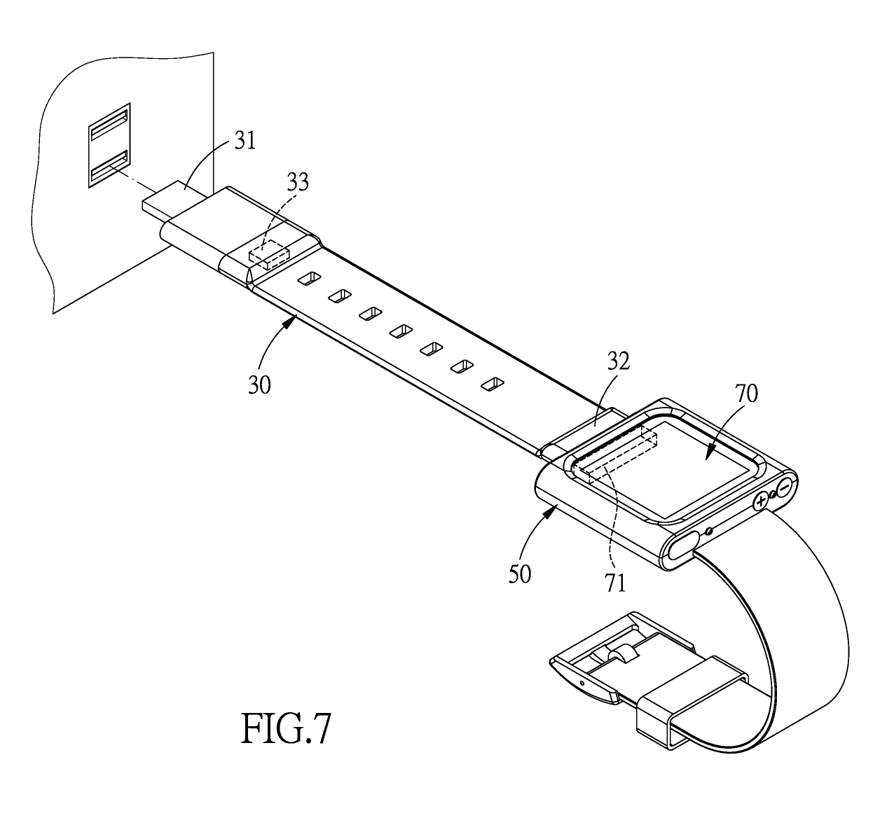

It is to be noted that, as shown in FIG. 7, the transmission member 30 has the USB connector 31 and the electronic-device connector 32 at both ends thereof, and the electronic-device connector 32 is connected to the connection port 71 of the electronic device 70, so that data transmission or charging can be performed without removing the outer cover assembly 50. Furthermore, the Bluetooth emitter 33 is embedded in the transmission member 30, the power of the Bluetooth emitter 33 comes from the power source of the electronic device 70, and the Bluetooth emitter 33 allows for wireless data transmission.

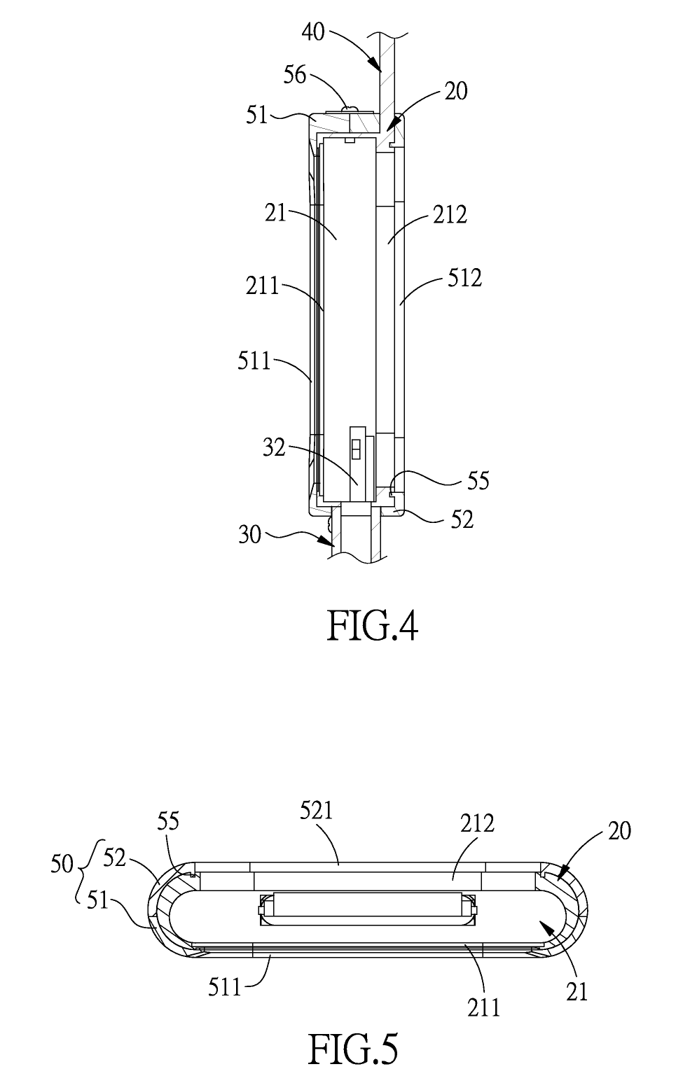

On top that, as shown in FIGS. 4 and 5, the inner surface of the bottom cover 52 is formed the annular rib 55, and when the outer cover assembly 50 covers the inner cover 20, the annular rib 55 will be pushed against the outer surface of the inner cover 20 to make the inner cover 20 and the electronic device 70 assembled more closely, thus improving the waterproof effect.

It is noted that the locking member 41 of the extension member 40 can further be provided with a receiving chamber (not shown) in the form of an opening or other closed structure to hold the USB connector 31 of the transmission member 30, thus providing protection for the USB connector 31, preventing oxidation which will affect the transmission of the USB connector 31.

While we have shown and described various embodiments in accordance with the present invention, it is clear to those skilled in the art that further embodiments may be made without departing from the scope of the present invention.

What is claimed is:

1. A protection and data transmission device suitable for use on a portable electronic device, the electronic device being provided with a connection port for connection of a power or signal cable, and the protection and data transmission device comprising:
an inner cover made of flexible material and including a receiving chamber for holding the electronic device, an upper opening and a lower opening being formed in the receiving chamber and located at two end surfaces of the inner cover;
a transmission member made of flexible material and formed at one end of the inner cover, the transmission member including a USB connector and an electronic-device connector at two ends thereof, the electronic-device connector being located in the receiving chamber and connected to the connection port;
an outer cover assembly with a top cover to the upper opening and a bottom cover to cover the lower opening, the outer cover assembly being formed with a plurality of assembling holes; and
a plurality of bolts screwed in the assembling holes to assemble the top and bottom covers together.

2. The protection and data transmission device suitable for use on a portable electronic device as claimed in claim 1, wherein a Bluetooth emitter is embedded in the transmission member.

3. The protection and data transmission device suitable for use on a portable electronic device as claimed in claim 1, wherein the electronic-device connector is a 30 pin connector.

4. The protection and data transmission device suitable for use on a portable electronic device as claimed in claim 1 further comprises a flexible-material made extension member connected to another end of the inner cover, at one end of the extension member are provided a locking frame and a locking pin, the transmission member is provided with a plurality of apertures and inserted in the locking frame in such a manner that the locking pin is inserted in one of the apertures.

5. The protection and data transmission device suitable for use on a portable electronic device as claimed in claim 1, wherein an inner surface of the bottom cover is formed an annular rib, and when the outer cover assembly covers the inner cover, the annular rib will be pushed against the outer surface of the inner cover.

6. The protection and data transmission device suitable for use on a portable electronic device as claimed in claim 1, wherein each of the assembling holes includes a longitudinal hole and a transverse hole, the longitudinal holes are formed in peripheral edges of the top and bottom covers and will be aligned in pairs when the outer cover assembly covers the inner cover, the transverse holes are formed on a plurality of ears which are located on the top and bottom covers, and the transverse holes will be aligned in pairs when the outer cover assembly covers the inner cover.
